(19) United States
(12) Patent Application Publication
(10) Pub. No.: US 2017/0222904 A1
(43) Pub. Date: Aug. 3, 2017

(54) Distributed Business Transaction Specific Network Data Capture

(71) Applicant: AppDynamics, Inc., San Francisco, CA (US)

(72) Inventors: Harish Nataraj, Berkeley, CA (US); Ajay Chandel, Fremont, CA (US); Naveen Kondapalli, San Ramon, CA (US)

(21) Appl. No.: 15/011,084

(22) Filed: Jan. 29, 2016

(51) Int. Cl. H04L 12/26; H04L 29/08

(52) U.S. Cl. CPC H04L 43/0876; H04L 43/062; H04L 67/10

(57) ABSTRACT

A system monitors applications as well as the network flows used during the business transaction, identifies network flows associate with a particular distributed business transaction, and reports the specific network flow data. A network flow associated with a business transaction is monitored by a network agent. The network agent may capture packets, and analyze the packets. Upon request by a user, packet capture can be performed for the specific data flows associated with a distributed business transaction. Concurrently with the network agent monitoring, application agents may monitor one or more applications performing the business transaction. The present system reports performance data for a business transaction in terms of application performance and network performance, all in the context of a distributed business transaction.

### BACKGROUND

The World Wide Web has expanded to provide numerous web services to consumers. The web services may be provided by a web application which uses multiple services and applications to handle a transaction. The applications may be distributed over several machines, making the topology of the machines that provide the service more difficult to track and monitor.

Monitoring a web application helps to provide insight regarding bottle necks in communication, communication failures and other information regarding performance of the services that provide the web application. Most application monitoring tools provide a standard report regarding application performance. Though the typical report may be helpful for most users, it may not provide the particular information that an administrator wants to know.

For example, when monitoring a web application, is important to provide as much detail as possible to a system administrator in order to correctly diagnose a problem. In many cases, a performance issue with an application is not due to the application itself, but rather due to a network that processes communications between multiple machines. It is difficult to determine how an application performance is affected by the network when only monitoring the application itself.

### SUMMARY

The present technology, roughly described, monitors applications as well as the network flows used during the business transaction, identifies network flows associated with a particular distributed business transaction, and reports the specific network flow data. A network flow associated with a business transaction is monitored by one or more network agents. The one or more network agents may capture packets and analyze the packets. Upon request by a user, packet capture can be performed for the specific data flows associated with a distributed business transaction. Concurrently with the network agent monitoring, application agents may monitor one or more applications performing the business transaction. The present system reports performance data for the business transaction in terms of application performance and network performance, all in the context of a distributed business transaction. This provides a detailed and informative picture to an administrator as to what is causing poor performance, with respect to applications and network flows used by business transaction, and how application performance depends on performance of a network flow.

Some implementations may include a method for correlating network data flow with a distributed business transaction. One or more network agents installed on each of a plurality of machines and at least one network may monitor a distributed business transaction over the plurality of machines. At least one of the network agents may receive a request from a remote server for network flow data associated with the monitored distributed business transaction. At least one of the network agents may collect the requested network flow data associated with the monitored distributed business transaction in response to the request.

Some implementations may include a system for correlating network data flow with a distributed business transaction. The system may include a processor, memory, and one or more modules stored in memory and executable by the processor. When executed, the modules may monitor, by one or more network agents installed on each of a plurality of machines and at least one network, a distributed business transaction over the plurality of machines. The executed modules may receive, by at least one of the network agents, a request from a remote server for network flow data associated with the monitored distributed business transaction. The executed modules may collect, by the at least one of the network agents, the requested network flow data associated with the monitored distributed business transaction in response to the request.

### BRIEF DESCRIPTION OF THE DRAWINGS

FIG. 1 is a block diagram of an exemplary system for monitoring a distributed business transaction performed by applications and at least one network flow.

FIG. 2 is an exemplary method for monitoring a network flow for a distributed business transaction.

FIG. 3 is an exemplary method for monitoring distributed business transactions by a network agent.

FIG. 4 is an exemplary method for processing and reporting distributed business transaction data by controller.

FIG. 5 illustrates an exemplary graphical user interface for displaying network flow data.

FIG. 6 is a block diagram of an exemplary computing environment for implementing the present technology.

### DETAILED DESCRIPTION

The present technology, roughly described, monitors applications as well as the network flows used during the business transaction, identifies network flows associate with a particular distributed business transaction, and reports the specific network flow data. A network flow associated with a business transaction is monitored by a network agent. The network agent may capture packets, and analyze the packets. Upon request by a user, packet capture can be performed for the specific data flows associated with a distributed business transaction. Concurrently with the network agent monitoring, application agents may monitor one or more applications performing the business transaction. The present system reports performance data for a business transaction in terms of application performance and network performance, all in the context of a distributed business transaction. This provides a detailed and informative picture to an administrator as to what is causing poor performance, with respect to applications and network flows used by business transaction, and how application performance depends on performance of a network flow.

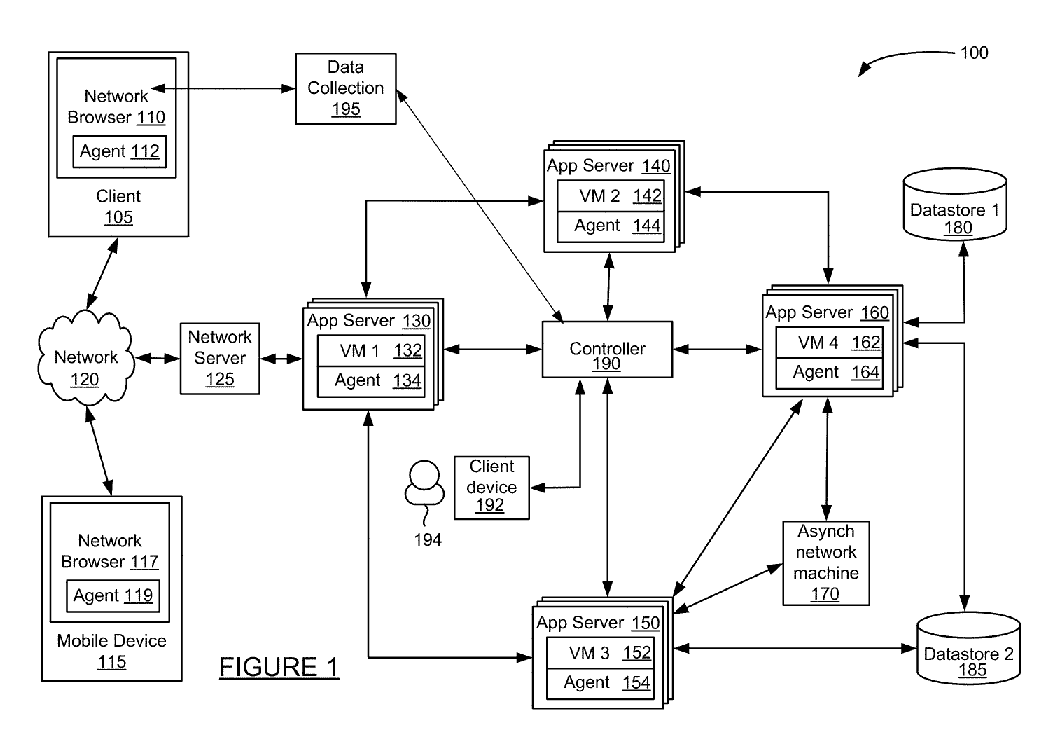

FIG. 1 is a block diagram of an exemplary system for monitoring a distributed business transaction. System 100 of FIG. 1 includes client device 105 and 192, mobile device 115, network 120, network server 125, application servers 130, 140, 150 and 160, asynchronous network machine 170, data stores 180 and 185, controller 190, and data collection server 195.

Client device 105 may include network browser 110 and be implemented as a computing device, such as for example a laptop, desktop, workstation, or some other computing device. Network browser 110 may be a client application for viewing content provided by an application server, such as application server 130 via network server 125 over network 120.

Network browser 110 may include agent 112. Agent 112 may be installed on network browser 110 and/or client 105 as a network browser add-on, downloading the application to the server, or in some other manner. Agent 112 may be executed to monitor network browser 110, the operation system of client 105, and any other application, API, or other component of client 105. Agent 112 may determine network browser navigation timing metrics, access browser cookies, monitor code, and transmit data to data collection 160, controller 190, or another device. Agent 112 may perform other operations related to monitoring a request or a network at client 105 as discussed herein.

Mobile device 115 is connected to network 120 and may be implemented as a portable device suitable for sending and receiving content over a network, such as for example a mobile phone, smart phone, tablet computer, or other portable device. Both client device 105 and mobile device 115 may include hardware and/or software configured to access a web service provided by network server 125.

Mobile device 115 may include network browser 117 and an agent 119. Mobile device may also include client applications and other code that may be monitored by agent 119. Agent 119 may reside in and/or communicate with network browser 117, as well as communicate with other applications, an operating system, APIs and other hardware and software on mobile device 115. Agent 119 may have similar functionality as that described herein for agent 112 on client 105, and may report data to data collection server 160 and/or controller 190.

Network 120 may facilitate communication of data between different servers, devices and machines of system 100 (some connections shown with lines to network 120, some not shown). The network may be implemented as a private network, public network, intranet, the Internet, a cellular network, Wi-Fi network, VoIP network, or a combination of one or more of these networks. The network 120 may include one or more machines such as load balance machines and other machines.

Network server 125 is connected to network 120 and may receive and process requests received over network 120. Network server 125 may be implemented as one or more servers implementing a network service, and may be implemented on the same machine as application server 130 or one or more separate machines. When network 120 is the Internet, network server 125 may be implemented as a web server.

Application server 130 communicates with network server 125, application servers 140 and 150, and controller 190. Application server 130 may also communicate with other machines and devices (not illustrated in FIG. 1). Application server 130 may host an application or portions of a distributed application. The host application 132 may be in one of many platforms, such as including a Java, PHP, .Net, and Node.JS, be implemented as a Java virtual machine, or include some other host type. Application server 130 may also include one or more agents 134 (i.e. “modules”), including an application agent, machine agent, and network agent, and other software modules. Application server 130 may be implemented as one server or multiple servers as illustrated in FIG. 1.

Application 132 and other software on application server 130 may be instrumented using byte code insertion, or byte code instrumentation (BCI), to modify the object code of the application or other software. The instrumented object code may include code used to detect calls received by application 132, calls sent by application 132, and communicate with agent 134 during execution of the application. BCI may also be used to monitor one or more sockets of the application and/or application server in order to monitor the socket and capture packets coming over the socket.

In some embodiments, server 130 may include applications and/or code other than a virtual machine. For example, server 130 may include Java code, .Net code, PHP code, Ruby code, C code or other code to implement applications and process requests received from a remote source.

Agents 134 on application server 130 may be installed, downloaded, embedded, or otherwise provided on application server 130. For example, agents 134 may be provided in server 130 by instrumentation of object code, downloading the agents to the server, or in some other manner. Agents 134 may be executed to monitor application server 130, monitor code running in a or a virtual machine 132 (or other program language, such as a PHP, .Net, or C program), machine resources, network layer data, and communicate with byte instrumented code on application server 130 and one or more applications on application server 130.

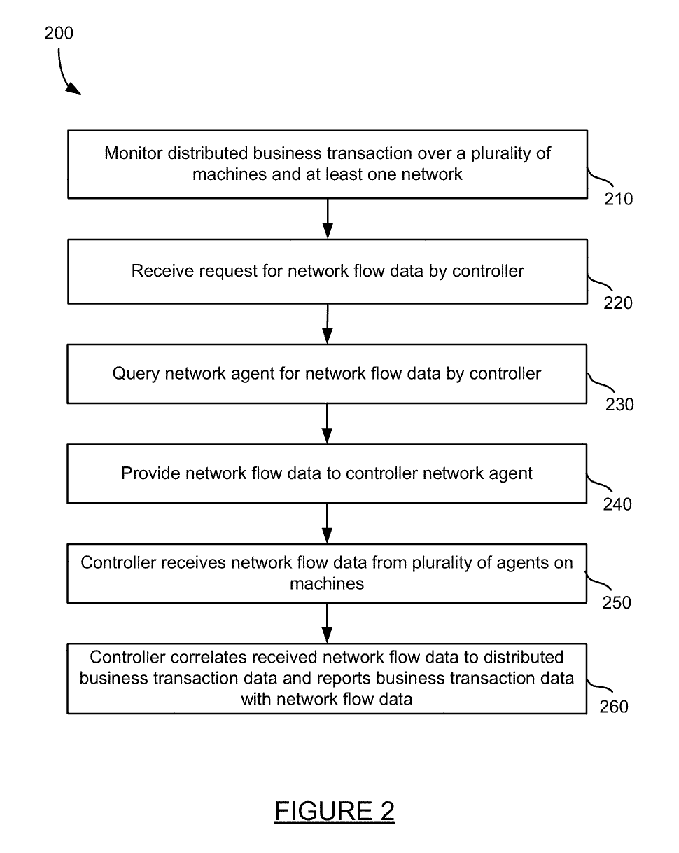

Each of agents 134, 144, 154 and 164 may include one or more agents, such as an application agents, machine agents, and network agents. An application agent may be a type of agent that is suitable to run on a particular host. Examples of application agents include a JAVA agent, .Net agent, PHP agent, and other agents. The machine agent may collect data from a particular machine on which it is installed. A network agent may capture network information, such as data collected from a socket. Agents are discussed in more detail below with respect to FIG. 2.

Agent 134 may detect operations such as receiving calls and sending requests by application server 130, resource usage, and incoming packets. Agent 134 may receive data, process the data, for example by aggregating data into metrics, and transmit the data and/or metrics to controller 190. Agent 134 may perform other operations related to monitoring applications and application server 130 as discussed herein. For example, agent 134 may identify other applications, share business transaction data, aggregate detected runtime data, and other operations.

An agent may operate to monitor a node, tier or nodes or other entity. A node may be a software program or a hardware component (e.g., memory, processor, and so on). A tier of nodes may include a plurality of nodes which may process a similar business transaction, may be located on the same server, may be associated with each other in some other way, or may not be associated with each other.

An application agent may be an agent suitable to instrument or modify, collect data from, and reside on a host. The host may be a Java, PHP, .Net, Node.JS, or other type of platform. Application agent 220 may collect flow data as well as data associated with the execution of a particular application. The application agent may instrument the lowest level of the application to gather the flow data. The flow data may indicate which tier is communicating which with which tier and on which port. In some instances, the flow data collected from the application agent includes a source IP, a source port, a destination IP, and a destination port. The application agent may report the application data and call chain data to a controller. The application agent may report the collected flow data associated with a particular application to network agent 230.

A network agent may be a standalone agent that resides on the host and collects network flow group data. The network flow group data may include a source IP, destination port, destination IP, and protocol information for network flow received by an application on which network agent 230 is installed. The network agent 230 may collect data by intercepting and performing packet capture on packets coming in from a one or more sockets. The network agent may receive flow data from an application agent that is associated with applications to be monitored. For flows in the flow group data that match flow data provided by the application agent, the network agent rolls up the flow data to determine metrics such as TCP throughput, TCP loss, latency and bandwidth. The network agent may then reports the metrics, flow group data, and call chain data to a controller. The network agent may also make system calls at an application server to determine system information, such as for example a host status check, a network status check, socket status, and other information.

A machine agent may reside on the host and collect information regarding the machine which implements the host. A machine agent may collect and generate metrics from information such as processor usage, memory usage, and other hardware information.

Each of the application agent, network agent, and machine agent may report data to the controller. Controller 210 may be implemented as a remote server that communicates with agents located on one or more servers or machines. The controller may receive metrics, call chain data and other data, correlate the received data as part of a distributed transaction, and report the correlated data in the context of a distributed application implemented by one or more monitored applications and occurring over one or more monitored networks. The controller may provide reports, one or more user interfaces, and other information for a user.

Agent 134 may create a request identifier for a request received by server 130 (for example, a request received by a client 105 or 115associated with a user or another source). The request identifier may be sent to client 105 or mobile device 115, whichever device sent the request. In embodiments, the request identifier may be created when a data is collected and analyzed for a particular business transaction.

Each of application servers 140, 150 and 160 may include an application and agents. Each application may run on the corresponding application server. Each of applications 142, 152 and 162 on application servers 140-160 may operate similarly to application 132 and perform at least a portion of a distributed business transaction. Agents 144, 154 and 164 may monitor applications 142-162, collect and process data at runtime, and communicate with controller 190. The applications 132, 142, 152 and 162 may communicate with each other as part of performing a distributed transaction. In particular each application may call any application or method of another virtual machine.

Asynchronous network machine 170 may engage in asynchronous communications with one or more application servers, such as application server 150 and 160. For example, application server 150 may transmit several calls or messages to an asynchronous network machine. Rather than communicate back to application server 150, the asynchronous network machine may process the messages and eventually provide a response, such as a processed message, to application server 160. Because there is no return message from the asynchronous network machine to application server 150, the communications between them are asynchronous.

Data stores 180 and 185 may each be accessed by application servers such as application server 150. Data store 185 may also be accessed by application server 150. Each of data stores 180 and 185 may store data, process data, and return queries received from an application server. Each of data stores 180 and 185 may or may not include an agent.

Controller 190 may control and manage monitoring of business transactions distributed over application servers 130-160. In some embodiments, controller 190 may receive application data, including data associated with monitoring client requests at client 105 and mobile device 115, from data collection server 160. In some embodiments, controller 190 may receive application monitoring data and network data from each of agents 112, 119, 134, 144 and 154. Controller 190 may associate portions of business transaction data, communicate with agents to configure collection of data, and provide performance data and reporting through an interface. The interface may be viewed as a web-based interface viewable by client device 192, which may be a mobile device, client device, or any other platform for viewing an interface provided by controller 190. In some embodiments, a client device 192 may directly communicate with controller 190 to view an interface for monitoring data.

Client device 192 may include any computing device, including a mobile device or a client computer such as a desktop, work station or other computing device. Client computer 192 may communicate with controller 190 to create and view a custom interface. In some embodiments, controller 190 provides an interface for creating and viewing the custom interface as a content page, e.g., a web page, which may be provided to and rendered through a network browser application on client device 192.

Applications 132, 142, 152 and 162 may be any of several types of applications. Examples of applications that may implement applications 132-162 include a Java, PHP, .Net, Node.JS, and other applications.

FIG. 2 is an exemplary method for monitoring a business transaction application and network flow. Distributed business transactions are monitored over a multiple machines at step 210. Multiple agents may be used to monitor the distributed business transaction. Application agents may be used to monitor applications that process requests and perform functions that make up the distributed business transaction. Network agents may be used to monitor one or more sockets that are used to process communications between the machines as part of a distributed business transaction.

Application data and call chain data may be collected for an application that processes business transactions by a language agent. The call chain data may include a series of machines and services that have previously processed an application transaction. The collected application data is aggregated into a series of metrics, such as response time, average time, and other data, and the aggregated application data and call chain data may be reported to a controller. The reported application data and call chain data are associated with a call chain, and are used to correlate with other reported data, such as network flow data and architecture data, at the controller.

Network flow data is collected for selected applications by a language agent. The network flow data may include a tuple of source IP, source port, destination IP, and destination port data. This network flow data is collected as a time series of tuples by monitoring the deepest levels of an application by the language agent. The network flow data may be collected at a socket and includes network layer data such as source IP, destination port, destination IP, and protocol data. Application flow data and call chain data are received from a language agent by the network agent. The call chain data and application flow data may be used by the network agent to identify network flow group data for processing and reporting to a controller by the network agent. The application metrics generated from the application data and network flow group metrics generated from network flow data may then be correlated using the call chain data at a controller. The controller may report the correlated application metrics and network flow group metrics for a particular distributed business transaction.

The controller may receive a request for network flow data, such as packet capture data, for the distributed business transaction, at step 220. Packet capture involves capturing and analyzing each and every packet that comes from a network interface. To capture each and every packet for a distributed system would be extremely time consuming. In the present system, however, because the network flow for a distributed application is known, packet capture can be performed at each and every socket that is associated with a distributed business transaction.

Once the request for network flow data (e.g., packet capture data) is received by a controller, the controller may instruct one or more network agents that monitor network flows for the particular distributed business transaction to capture network flow data (e.g., perform packet capture to obtain packet capture data) at step 230. In response to the selection received from a user through an interface, the controller may identify the network agents on the machines along the network path of the distributed business transaction, generate instructions for them to perform packet capture for a period of time, such as for example then minutes or one hour, and transmit the instructions to the network agents.

In response to the controller instructions, the one or more network agents can collect network flow data and report the collected network flow data back to the controller at step 240. Capturing network flow data can include performing packet capture for packets that come in over a network interface associated as part of the distributed business transaction. The network agent identifies network flow group data received from a network interface that matches network flow data information associated with the distributed business transaction (which the network agent may already have or receive from a controller or other agent). The captured and identified network flow group data collected for subsequent upload to the controller. Network flow group data not matching the network flow data is discarded, while network flow group data matching the network flow data is kept and stored in a .pcap file The captured packet file (e.g., .pcap file) may be reported to the controller by the network agent.

The controller may receive the network flow data from the one or more network agents associated with the distributed business transaction at step 250. The controller correlates the received network flow data with a distributed business transaction and reports the correlated network flow data at step 260.

Correlating the network flow data may include stitching portions of the network flow data received from different network agents into groups of network flow data associated with a particular business transaction. The correlation may be performed using Internet protocol address information, call chain data, business transaction identification information, and other data.

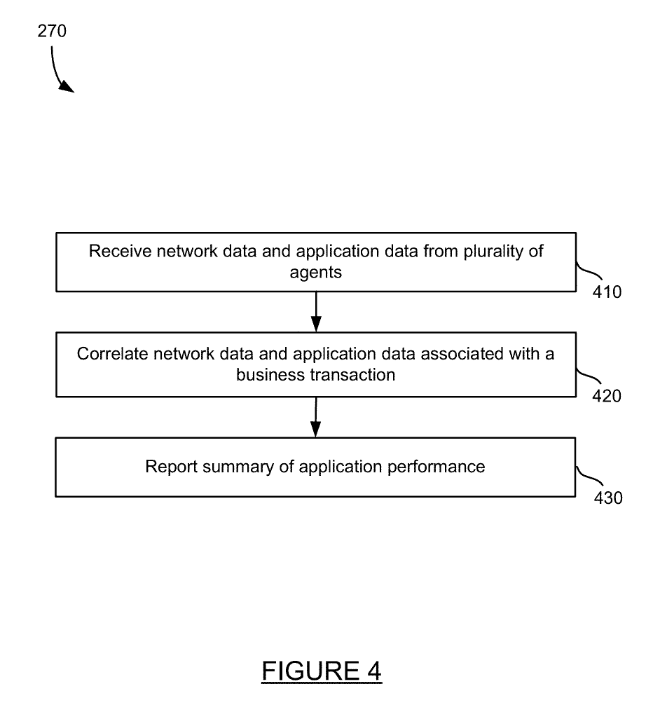

The reporting of network flow data, network flow metrics, and other data may involve providing one or more call graphs, snapshots of anomaly information, annotations on one or more graphs within an interface and other data within a graphical interface provided to a user. Network flow data captured and rolled into metrics, by network agents in response to the controller request are provided to a user through a graphical interface that illustrates the network architecture, such as hops, load balancers, and other machines, and metrics associated with each hop. Correlating and reporting the received network flow and business transaction data (such as the network architecture that is used by the distributed business transaction) by a controller is discussed in more detail below with respect to the method of FIG. 4.

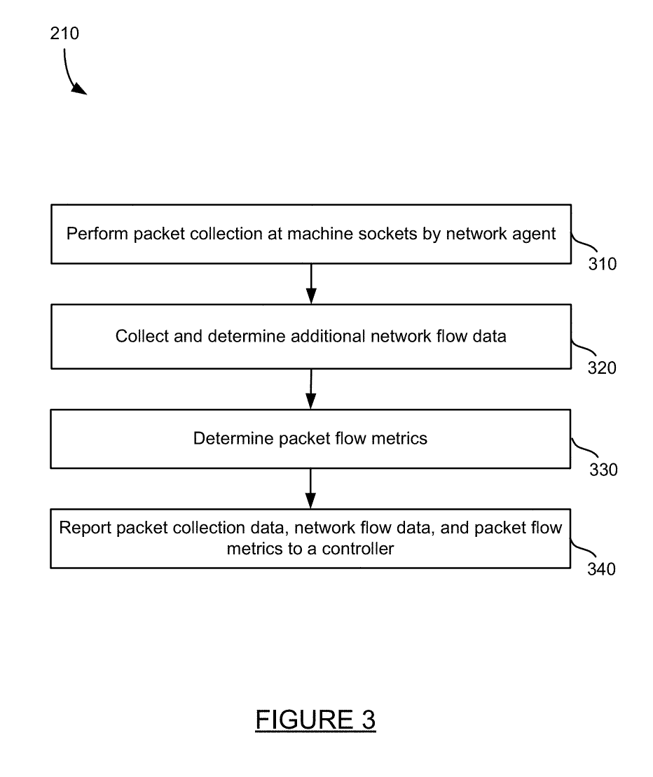

FIG. 3 is an exemplary method for monitoring distributed business transactions by network agent. The method of FIG. 3 provides more detail for step 210 of the method of FIG. 2. Packet collection is performed at machine sockets by one or more network agents at step 310. In addition to collecting packets, additional network flow data is collected at step 320. The additional data may include TCP header data, IP sequence numbers, TCP control flags and data, acknowledgment information, and other data. The additional network flow data may also include tuples for each socket, such as a source IP, destination IP, source port and destination port for each socket. Network flow metrics are determined for each network flow at step 330. The network flow metrics can include latency, throughput and relay transmission data for each network flow. The packet collection data, network flow data, and packet flow metrics (e.g., latency, throughput) may be reported to the controller by a network agent at step 340.

FIG. 4 is an exemplary method for processing and reporting business transaction data by a controller. The method of FIG. 4 provides more detail for step 260 the method of FIG. 2. A controller receives network data and application data from agents at step 410. The network data and application data may be received periodically from agents from multiple machines, or in response to an event such as detection of an anomaly.

Network data and application data associated with a business transaction may be correlated together at step 420. Correlating network data and application data by the controller results in forming groups of data associated with a business transaction. The network data and application data may be correlated together using portions of network data and application data within snapshots and/or other data provided by the application agents and network agents to the controller. For example, the network data provided by the network agent (for instance, submitted by the application agent on behalf of the network agent) may include IP addresses associated with a source machine and destination machine utilizing a particular network flow. Application data provided by an application agent may also include a source address and destination address data collected by an application agent and associated with a particular business transaction. As a result, the controller may stitch together the network data to the corresponding application data based on the matching IP address data and the corresponding time at which the applications took place. Additionally, when network flow data is transmitted to the controller by an application agent, the application agent may insert business transaction identification information into the network flow data. The controller may then associate application data and network flow data based on the business transaction identification information data in both sets of data.

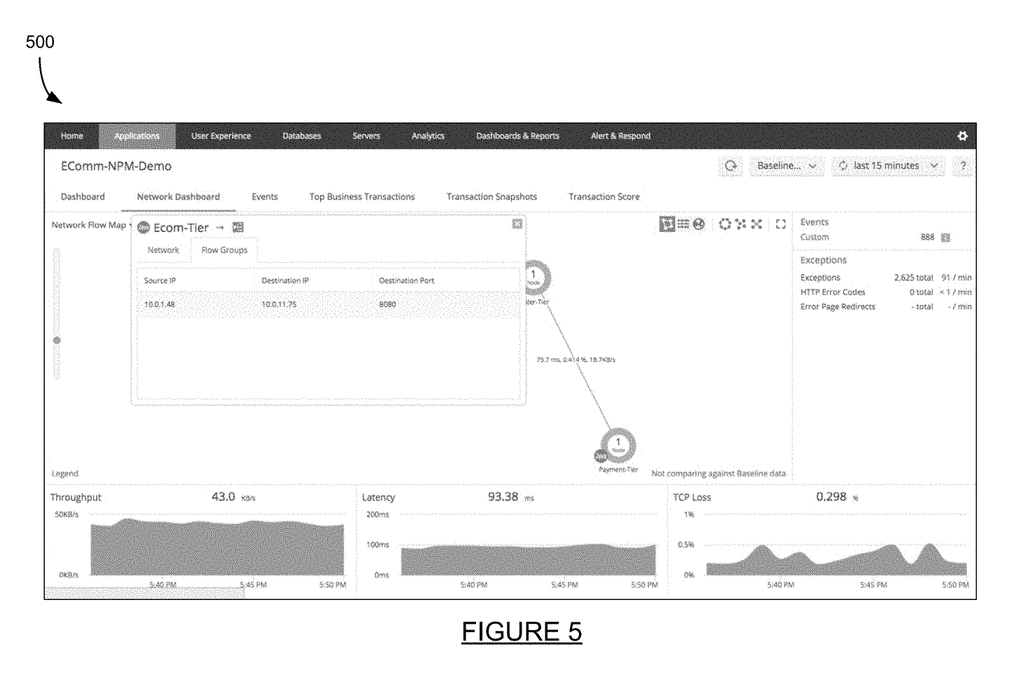

A summary of the application performance is provided at step 430. In some instances, the summary may be provided in one of several formats. One example of a summary of the application performance can be provided in the form of a call graph or graphical user interface such as that shown in FIG. 5.

FIG. 5 illustrates an exemplary graphical user interface for displaying network flow data. The interface of FIG. 5 provides network flow data of throughput, latency and TCP loss. The network flow data is provided in terms of total average network flow data for a distributed business transaction. For example, the throughput and TCP loss of 43 KB/s and 0.298%, respectively, may represent the average total throughput and TCP loss for the distributed business transaction pictured in the interface.

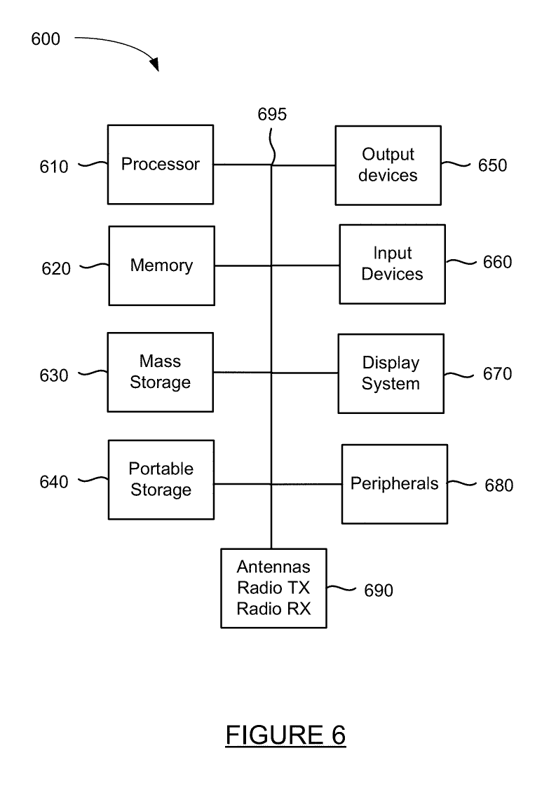

FIG. 6 is an exemplary block diagram of a system for implementing the present technology. System 600 of FIG. 6 may be implemented in the contexts of the likes of client computer 105 and 192, servers 125, 130, 140, 150, and 160, machine 170, data stores 180 and 190, and controller 190. The computing system 600 of FIG. 6 includes one or more processors 610 and memory 620. Main memory 620 stores, in part, instructions and data for execution by processor 610. Main memory 620 can store the executable code when in operation. The system 600 of FIG. 6 further includes a mass storage device 630, portable storage medium drive(s) 640, output devices 650, user input devices 660, a graphics display 670, and peripheral devices 680.

The components shown in FIG. 6 are depicted as being connected via a single bus 690. However, the components may be connected through one or more data transport means. For example, processor unit 610 and main memory 620 may be connected via a local microprocessor bus, and the mass storage device 630, peripheral device(s) 680, portable storage device 640, and display system 670 may be connected via one or more input/output (I/O) buses.

Mass storage device 630, which may be implemented with a magnetic disk drive, an optical disk drive, a flash drive, or other device, is a non-volatile storage device for storing data and instructions for use by processor unit 610. Mass storage device 630 can store the system software for implementing embodiments of the present invention for purposes of loading that software into main memory 620.

Portable storage device 640 operates in conjunction with a portable non-volatile storage medium, such as a floppy disk, compact disk or Digital video disc, USB drive, memory card or stick, or other portable or removable memory, to input and output data and code to and from the computer system 600 of FIG. 6. The system software for implementing embodiments of the present invention may be stored on such a portable medium and input to the computer system 600 via the portable storage device 640.

Input devices 660 provide a portion of a user interface. Input devices 660 may include an alpha-numeric keypad, such as a keyboard, for inputting alpha-numeric and other information, a pointing device such as a mouse, a trackball, stylus, cursor direction keys, microphone, touch-screen, accelerometer, and other input devices Additionally, the system 600 as shown in FIG. 6 includes output devices 650. Examples of suitable output devices include speakers, printers, network interfaces, and monitors.

Display system 670 may include a liquid crystal display (LCD) or other suitable display device. Display system 670 receives textual and graphical information, and processes the information for output to the display device. Display system 670 may also receive input as a touch-screen.

Peripherals 680 may include any type of computer support device to add additional functionality to the computer system. For example, peripheral device(s) 680 may include a modem or a router, printer, and other device.

The system of 600 may also include, in some implementations, antennas, radio transmitters and radio receivers 690. The antennas and radios may be implemented in devices such as smart phones, tablets, and other devices that may communicate wirelessly. The one or more antennas may operate at one or more radio frequencies suitable to send and receive data over cellular networks, Wi-Fi networks, commercial device networks such as a Bluetooth devices, and other radio frequency networks. The devices may include one or more radio transmitters and receivers for processing signals sent and received using the antennas.

The components contained in the computer system 600 of FIG. 6 are those typically found in computer systems that may be suitable for use with embodiments of the present invention and are intended to represent a broad category of such computer components that are well known in the art. Thus, the computer system 600 of FIG. 6 can be a personal computer, hand held computing device, smart phone, mobile computing device, workstation, server, minicomputer, mainframe computer, or any other computing device. The computer can also include different bus configurations, networked platforms, multi-processor platforms, etc. Various operating systems can be used including Unix, Linux, Windows, iOS, Android, C, C++, Node.JS, and other suitable operating systems.

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen in order to best explain the principles of the technology and its practical application to thereby enable others skilled in the art to best utilize the technology in various embodiments and with various modifications as are suited to the particular use contemplated. It is intended that the scope of the technology be defined by the claims appended hereto.

What is claimed is:

1. A method for correlating network data flow with a distributed business transaction, comprising:
monitoring, by one or more network agents installed on each of a plurality of machines and at least one network, a distributed business transaction over the plurality of machines;
receiving, by at least one of the network agents, a request from a remote server for network flow data associated with the monitored distributed business transaction; collecting, by the at least one of the network agents, the requested network flow data associated with the monitored distributed business transaction in response to the request.

2. The method of claim 1, wherein collecting the network flow data includes identifying a plurality of sockets through which a network path flows for the distributed business transactions.

3. The method of claim 1, wherein collecting the network flow data includes performing packet capture for network flows associated with the distributed business transaction

4. The method of claim 1, wherein receiving the request includes receiving the request through an interface provided by the remote server.

5. The method of claim 1, wherein monitoring includes capturing each packet of a network flow associated with the distributed business transaction.

6. The method of claim 1, wherein monitoring includes collecting metrics associated with performance of a network flow between one or more of the plurality of machines that process the distributed business transaction.

7. The method of claim 1, further comprising identifying a network flow between two of the plurality of machines that have address locations that match address locations of machines which process the distributed business transaction.

8. The method of claim 1, further comprising reporting, by the at least one of the network agents, the collected network flow data associated the distributed business transaction to a remote server.

9. A non-transitory computer readable storage medium having embodied thereon a program, the program being executable by a processor to perform a method for correlating network data flow with a distributed business transaction, the method comprising:
monitoring, by one or more network agents installed on each of a plurality of machines and at least one network, a distributed business transaction over the plurality of machines;
receiving, by at least one of the network agents, a request from a remote server for network flow data associated with the monitored distributed business transaction; and
collecting, by the at least one of the network agents, the requested network flow data associated with the monitored distributed business transaction in response to the request

10. The non-transitory computer readable storage medium of claim 9, wherein collecting the network flow data includes identifying a plurality of sockets through which a network path flows for the distributed business transactions.

11. The non-transitory computer readable storage medium of claim 9, wherein collecting the network flow data includes performing packet capture for network flows associated with the distributed business transaction

12. The non-transitory computer readable storage medium of claim 9, wherein receiving the request includes receiving the request through an interface provided by the remote server.

13. The non-transitory computer readable storage medium of claim 9, wherein monitoring includes capturing each packet of a network flow associated with the distributed business transaction.

14. The non-transitory computer readable storage medium of claim 9, wherein monitoring includes collecting metrics associated with performance of a network flow between one or more of the plurality of machines that process the distributed business transaction.

15. The non-transitory computer readable storage medium of claim 9, the method further comprising identifying a network flow between two of the plurality of machines that have address locations that match address locations of machines which process the distributed business transaction.

16. The non-transitory computer readable storage medium of claim 9, further comprising reporting, by the at least one of the network agents, the collected network flow data associated the distributed business transaction to a remote server.

17. A system for correlating network data flow with a distributed business transaction, the system comprising:
a server including a memory and a processor; and
one or more modules stored in the memory and executed by the processor to monitor, by one or more network agents installed on each of a plurality of machines and at least one network, a distributed business transaction over the plurality of machines, receive, by at least one of the network agents, a request from a remote server for network flow data associated with the monitored distributed business transaction, collect, by the at least one of the network agents, the requested network flow data associated with the monitored distributed business transaction in response to the request.

18. The system of claim 17, wherein collecting the network flow data includes identifying a plurality of sockets through which a network path flows for the distributed business transactions.

19. The system of claim 17, wherein collecting the network flow data includes performing packet capture for network flows associated with the distributed business transaction

20. The system of claim 17, wherein receiving the request includes receiving the request through an interface provided by the remote server.

21. The system of claim 17, wherein monitoring includes capturing each packet of a network flow associated with the distributed business transaction.

22. The system of claim 17, wherein monitoring includes collecting metrics associated with performance of a network flow between one or more of the plurality of machines that process the distributed business transaction.

23. The system of claim 17, the modules further executable to identify a network flow between two of the plurality of machines that have address locations that match address locations of machines which process the distributed business transaction.

24. The system of claim 17, further comprising reporting, by the at least one of the network agents, the collected network flow data associated the distributed business transaction to a remote server.
